(19) United States
(12) Patent Application Publication
(10) Pub. No.: US 2007/0135118 A1
(43) Pub. Date: Jun. 14, 2007

(54) Device and method for transmission of data over a telephone line

(76) Inventor: Matthias Zahn, Munich, DE (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/607,105

(22) Filed: Dec. 1, 2006

Related U.S. Application Data
(63) Continuation of application No. PCT/EP05/06068, filed on Jun. 6, 2005.

(30) Foreign Application Priority Data
Jun. 4, 2004 (DE) 102004027406.1

(51) Int. Cl. H04Q 7/20

(52) U.S. Cl. 455/426.1

(57) ABSTRACT

A device for the transmission of data over a telephone line provides a simple and economical interactive television service, whereby the device includes the following: a first connector for connection of a fixed line telephone to the device, an HF receiver for receiving data transmitted to the device by radio and/or an HF transmitter for transmission of data from the device to a peripheral device by radio, and a modem device for remote transmission of data from the device by the fixed line connection and/or for receipt of data transmitted to the device via the fixed line connection.

### CROSS REFERENCE TO RELATED APPLICATIONS

This application is a continuation of International Application No. PCT/EP2005/006068, filed on Jun. 6, 2005, entitled “Device and Method for Transmission of Data Over a Telephone Line,” which claims priority under 35 U.S.C. §119 to Application No. DE 102004027406.1 filed on Jun. 4, 2004, entitled “Device and Method for Transmission of Data Over a Telephone Line,” the entire contents of which are hereby incorporated by reference.

### FIELD OF THE INVENTION

The present invention relates to an apparatus for transmission of data over a telephone line. The present invention also relates to a method for transmission of data over a telephone line. Finally, the present invention relates to a system for provision of an interactive television service.

### BACKGROUND

In the prior art, telephones, in particular landline telephones, are known by means of which users can react to specific events, which are initiated for example by a television program, such as the request to take part in a game or a vote, in that they manually dial a predetermined call number and make appropriate inputs, such as a speech input in response to a quiz question which has been posed. This has a large number of disadvantages. The participation in a game, vote etc., is relatively complex for a user. The provision of one or more telephone numbers is also costly for a television transmitter managing an event such as this, and the majority of the profit goes to the telecommunication concerns.

### SUMMARY

The invention is based on the object of avoiding the disadvantages of the prior art and, in particular, of providing a back-channel in a simple and cost-effective manner over the telephone network, in particular in order to provide interactive television.

This object is achieved in the case of an apparatus of the type mentioned initially in that the apparatus has the following:
a first connection in order to connect a landline telephone to the apparatus,
a second connection in order to connect the apparatus to a landline telephone connection;
an RF receiver in order to receive data transmitted by radio to the apparatus, and/or an RF transmitter in order to transmit data by radio from the apparatus to a peripheral device; and
a modem device, in order to transmit data from the apparatus over long distances via the landline connection and/or to receive data transmitted to the apparatus via the landline connection.

One advantage of the present invention is that the apparatus according to the invention can be used to drive devices of any type and to pass on data which has been detected by sensors of any type. Devices in the house or apartment of a user can thus be controlled externally and remotely via the apparatus according to the invention. Data detected in the house or apartment of a user can likewise be transmitted over long distances via the apparatus according to the invention.

The apparatus also advantageously has a memory device in order to store the data which has been transmitted by radio or via the landline connection to the apparatus. This allows large amounts of data to be received completely, and to be checked before being passed on according to the invention. This likewise allows data to be passed on with a time delay, that is to say for example when the landline telephone is in use, it is not interfered with, or the telephone charges are reduced by a large amount of data being transmitted jointly and at an advantageous time.

It is also preferable for the apparatus additionally to have a clock in order to initiate transmission of the data, which has been stored in the apparatus, over a long distance in response to a predetermined time (or a predetermined calendar date) being reached. Alternatively or in addition to this, according to one preferred variant of the present invention, long-distance transmission of the data which has been stored in the apparatus is initiated in response to the data which has been stored in the memory device reaching a predetermined memory occupancy.

The apparatus furthermore advantageously has a central processing unit, with the central processing unit which is provided in particular for processing of the data which has been transmitted to the apparatus and/or has been stored in the apparatus, for long-distance transmission.

The apparatus preferably has a telephone cable at one of whose ends the second connection, preferably a plug device, is formed, and at whose other end a physical unit is formed, which has the first connection, preferably a socket device. The physical unit is preferably in the form of a compact housing, thus giving the impression of an extension cable or intermediate plug for the apparatus according to the invention.

In order to supply the apparatus with electrical power, it is preferable for the apparatus also to have a power supply device, which takes the electrical power which is required for operation of the apparatus from the landline connection. This results in power being supplied in a particularly simple and cost-effective manner.

In this case, the power supply device advantageously has at least two operating modes for supplying power, with a first operating mode being defined in that, when the landline connection is in the rest state, the power supply device takes power from the landline connection, with the resistance of the apparatus being greater than or equal to a first predetermined resistance value, and with a second operating mode being defined in that, in the busy state of the landline connection, the power supply device takes power from the landline connection, with the resistance of the apparatus being greater than or equal to a second predetermined resistance value. In this case, the first predetermined resistance value is advantageously higher than the second predetermined resistance value. In particular, in this case, the first predetermined resistance value for the first operating mode is preferably approximately 1 MOhm and the second predetermined resistance value for the second operating mode is preferably approximately 700 Ohms. A tapping such as this is compliant with the relevant legal regulations, see, for example, the “Licensing regulation for terminal devices for connection to analogue dialed connections (except for emergency call and direct-dial connections) in the telephone network/ISDN provided by Deutschen Telekom AG” (BAPT 223 ZV 5) issued by the German Federal Ministry for Post and Telecommunications, D-52175 Bonn, Order No. 407 223 005-1.

The power supply device preferably also has storage means in order to store the power which has been taken from the landline telephone connection in the first and second operating modes. In this case, it is preferable that the second operating mode is initiated automatically at a predetermined time and/or in response to the detection that a minimum threshold has been reached for the amount of power stored in the storage means by the apparatus. The storage means is preferably a replaceable, rechargeable battery which is arranged in the apparatus.

According to one particularly practicable variant of the invention, the physical unit has one or more of the following components: the second connection; the RF receiver; the RF receiver; the modem device; the memory device; the clock; the central processing unit; the power supply device; and/or the storage means.

It is furthermore preferable for the RF receiver and the RF transmitter to be in the form of an RF transceiver. The RF receiver is preferably continuously ready to receive. This allows the apparatus according to the invention to be operated in the background, and without being noticed by the user.

The modem device advantageously initiates a dialed connection for long-distance transmission of the data in response to the reception of data which has been transmitted to the apparatus by radio. Alternatively or in addition to this, it is preferable that the modem device initiates a dialed connection for taking power from the landline connection on the basis of the second operating mode in response to the detection of a lower threshold for the power which is stored in an energy store for the power supply device.

The data which has been transmitted to the apparatus by radio is advantageously decoded and is coded again for long-distance transmission.

In order to allow normal telephone operation despite the apparatus being connected, the intention is for the landline telephone which is connected to the apparatus to be looped through the apparatus. This is preferably done in such a manner that the landline telephone which is connected to the apparatus is conductively connected to the landline telephone connection when the apparatus is not activated for long-distance transmission of data, while the landline telephone is conductively isolated from the landline telephone connection when the apparatus is activated for long-distance transmission of data.

It is likewise preferable in order to provide telephone operation of the connected landline telephone with as little impediment as possible that the apparatus also has a detection device which can detect that the landline telephone which is connected to the apparatus has gone off-hook, with any dialed connection which has been initiated by the modem device of the apparatus being interrupted when it is detected that the landline telephone has gone off-hook.

In order to achieve additional functionalities of the apparatus according to the invention, for example as a prefix dialer, the apparatus has means in order to identify a DTMF dialing signal of the landline telephone which is connected to the apparatus, and/or the apparatus has means in order to store a DTMF dialing signal of the landline telephone which is connected to the apparatus, in the apparatus, and/or the apparatus has means in order to change a DTMF dialing signal of the landline telephone which is connected to the apparatus. The latter variant is particularly preferable in conjunction with an additional usage option as a least cost router.

The apparatus preferably furthermore has means in order in each case to determine the best telephone tariff for the connected landline telephone and/or the long-distance data transmission of the apparatus, and to set up a connection in accordance with the tariff.

The RF receiver advantageously receives data which has been transmitted to the apparatus by radio from a large number of peripheral devices, with the data which has been transmitted to the apparatus from in each case one peripheral device having an individual identification code for that peripheral device.

According to a further aspect of the present invention, the object according to the invention is achieved by a system for provision of an interactive television service, characterized by an apparatus as claimed in one of the preceding claims, and by a peripheral device for a television set, which has a receiving device in order to receive additional data, which is transmitted to a television set, together with the television signal, has a transmission device in order to transmit data to the apparatus.

In this case, it is preferable that the additional data is contained in the program signal and is tapped off at the television set, is decoded, and is transmitted via a radio interface to the peripheral device. The peripheral device is preferably a remote control for the television set.

Finally, the object according to the invention is achieved according to a further aspect of the present invention by a method for transmission of data over a telephone line, having an apparatus for transmission of data over a telephone line, with the method comprising the following:
reception of data which has been transmitted to the apparatus by radio;
temporary storage of the data; and
long-distance transmission of the data via a landline connection;
   with a landline telephone being connected to the apparatus in such a manner that its operating capability is not substantially adversely affected by the apparatus.

Further preferred embodiments of the invention are disclosed in the dependent patent claims.

The invention as well as further features, aims, advantages and application options for it will be explained in more detail in the following text with reference to a description of preferred exemplary embodiments and with reference to the attached drawings. In the drawings, the same reference symbols denote the same or corresponding elements. In this case, all of the features which are described and/or are illustrated in the figures form the subject matter of the present invention in their own right or in any desired worthwhile combination, to be precise irrespective of the way in which they are summarized in the patent claims or their back-reference. In the drawings:

### BRIEF DESCRIPTION OF THE DRAWINGS

FIG. 1 shows a schematic illustration of one exemplary embodiment of the apparatus according to the invention, in the form of a block diagram; and

FIG. 2 shows a schematic illustration in order to provide an overview of the overall system of one preferred application of the present invention to the field of interactive television; and FIG. 3 shows a schematic illustration in order to explain the overall system shown in FIG. 2, in further detail.

### DETAILED DESCRIPTION

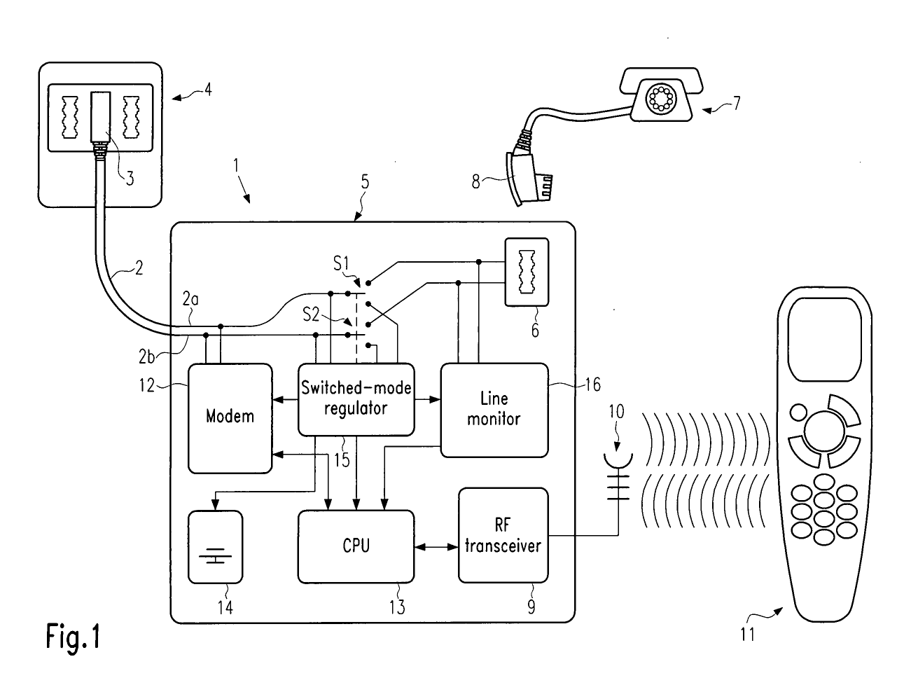

One preferred exemplary embodiment of the apparatus 1 according to the invention for transmission of data over a telephone line will be described with reference to FIG. 1. The apparatus 1 preferably has a section in the form of a telephone cable 2. At one of its ends, a plug device 3, that is to say a telephone plug, is formed, and is inserted into a landline telephone connection 4 in the operating state. FIG. 1 shows a conventional TAE telephone socket, whose center connection is intended for a landline telephone. At the other end of the telephone cable 2, a physical unit 5 is formed, in which various functionalities of the apparatus 1 are integrated, as will be explained in more detail in the following text. In particular, the physical unit 5 has a socket device 6, that is to say a socket, for connection of a telecommunication terminal, for example a landline telephone 7. The apparatus 1 thus results in the landline telephone 7, in the connected state (not illustrated), that is to say with the plug 8 of the landline telephone 7 inserted in the socket 6 and with the switches S1 and S2 in the closed, upper (in FIG. 1) switch positions, being looped through the apparatus 1 via the cable 2 to the landline connection 4. Opening of the switches S1 and S2 (in the lower switch position in FIG. 1) allows conductive decoupling of the telephone 7 from the connection 4. In this latter operating state, signals or data originating from the apparatus 1 can be transmitted over long distances via the landline connection 4.

In particular, an RF receiver 9, which is preferably a transceiver, is provided in the physical unit or in the housing section 5. The apparatus 1 can interchange data via the RF receiver 9 and the antenna 10 with a peripheral device, in particular for a television set, and preferably with a remote control 11 for the television set, and in particular can receive data from the remote control 11. By way of example, a wire-free connection is provided for this purpose between the apparatus 1 and the peripheral device, that is to say as illustrated in FIG. 1, the remote control 11, using one of the free ISM bands. In this case, the data is preferably transmitted between the apparatus 1 and the peripheral device in accordance with the DECT Standard. A modem device 12 is also provided in the apparatus 1, in order to transmit data over long distances via the landline telephone connection 4. The modem device 12 is preferably a packet modem with a low latency level, and in particular is a modem of particularly simple design for high-speed, power-saving data transmission, which can be operated without complex procedures for measurement of the data link or line. In particular, the modem 12 is an acoustic modem and allows a high-speed, cryptographically secure, dialog, which is compatible with mass-market applications. A CPU (central processing unit) 13 is likewise provided in the housing 5, for sequence control for the various functionalities of the apparatus 1. The CPU 13 in this case preferably has a real time clock (RTC).

In principle, in order to supply the electronic components in the apparatus 1, it is possible for the apparatus 1 to be connected to the power supply system via a power cable. Operation by means of a (replaceable) battery is likewise possible. However, it is preferable for the apparatus 1 in FIG. 1 to have schematically shown storage means 14 in order to store the electrical power which is required for operation and has been taken from the landline network via the connection 4, by means of a power supply device. In this case, the power supply device has at least two operating modes for supplying power, with a first operating mode being defined in that when the landline connection is in the rest state, the power supply device takes power from the landline connection, with the resistance, or leakage-current resistance, of the apparatus being greater than or equal to a first predetermined resistance value, preferably of about 1 MOhm, and with a second operating mode being defined in that, in the busy state of the landline connection, the power supply device takes power from the landline connection via the off-hook current, with the resistance of the apparatus being greater than or equal to a second predetermined resistance value, preferably of approximately 700 Ohms. This allows power to be taken from the telephone network for operation of the apparatus 1 in compliance with the relevant regulations for telecommunication. In this case, by way of example, the storage means 14 may be in the form of a rechargeable battery or an appropriately configured capacitor. In particular, it is thus preferable for the apparatus 1 to continuously take its supply of a permissible small amount of power from the landline network. When the landline telephone 7 is off-hook, a considerably greater amount of power can then be taken from the landline network, legally. Excess power in each case, that is to say electrical power which has been tapped off the landline network but is not required by the apparatus 1, is (temporarily) stored in the storage means 14. In this case, it is also preferable for the apparatus 1, in particular and especially for the purpose of supplying it with power, to periodically initiate a call (triggered by the RTC) or if a power demand is detected, for example going off-hook and connection for 1 minute, in order to draw power from the landline network on the basis of the second operating mode. Connections such as these can also be used for the transmission of other data from and to the apparatus 1. Examples of this are software updates or information about telephone tariffs (in this context, see for example the following statements relating to the switched-mode regulator as a least cost router).

The power supply device is in this case formed by the CPU 13 and by a switched-mode regulator 15 which is connected to the two telephone lines 2a, 2b. The storage means is charged on the basis of the operating modes via the switched-mode regulator 15. In particular, the required different resistances for taking power and for tapping off from the telephone landline network are also provided in the switched-mode regulator 15. This is done, for example, by switching resistors (not shown) which are provided in the circuit regulator. The switched-mode regulator 15 in this case also drives the switches S1 and S2 for decoupling of the landline telephone 7.

Furthermore, the apparatus 1 has a line monitoring device or line monitor 16. The line monitor 16 identifies when the landline telephone 7 is off-hook, and immediately interrupts its own call of the apparatus 1. This is done by appropriate signaling from the monitor 16 to the CPU 13 which itself drives the switched-mode regulator 15, which once again closes the switches S1 and S2. Furthermore, the line monitor 16 has a further functionality in that it can identify, store and/or specifically change or extend the DTMF dialing signal of the landline telephone 7. This also allows the apparatus 1 to form a so-called prefix dialer or a device for dialing the best telephone tariff (least cost router).

In principle, there are a large number of applications for the apparatus 1. Without significantly adversely affecting the telecommunication terminal, such as the telephone 7, the apparatus 1 according to the invention makes it possible to transmit widely differing data and signals, for example warning signals, control signals, switching signals, sensor values etc., from and to devices within range of the ISM or RF radio receivers and/or transmitters. Peripheral units which are located within range of the RF transceiver can thus communicate autonomously via the telephone network. In particular, it is also possible to handle transactions (placing orders, transferring money), so to speak, in the background. In this case, data which has been received via the antenna 10 and the RF transceiver 9 is stored in a memory device (not shown) in the apparatus 1. Depending on the requirement, the data is also, for example, gathered and/or is transmitted, delayed in time, via the modem circuit 12 over the telephone network. Conversely, any desired peripheral unit can be driven via a call from the landline network identifying it, for example by means of a special tag, from the CPU 13, via the RF transceiver 13.

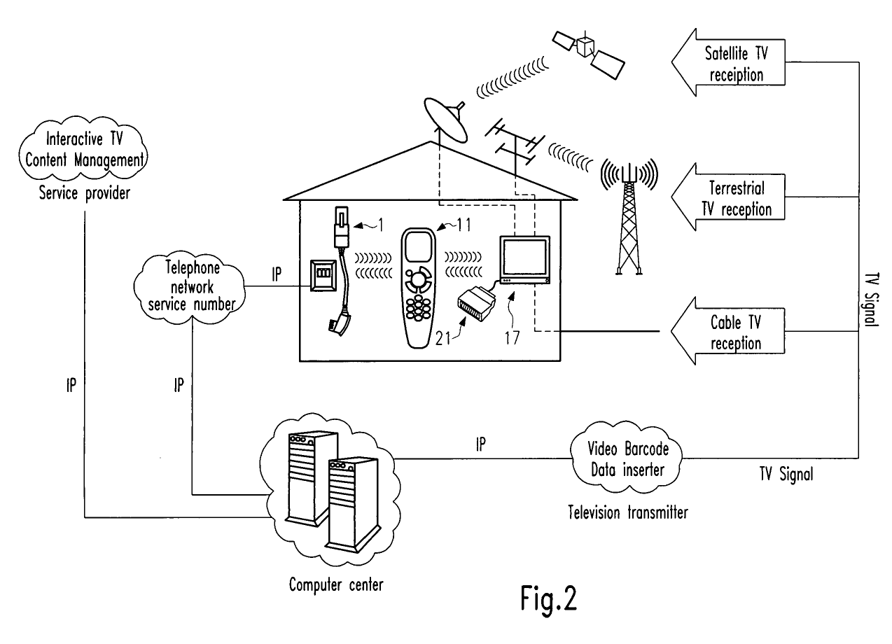

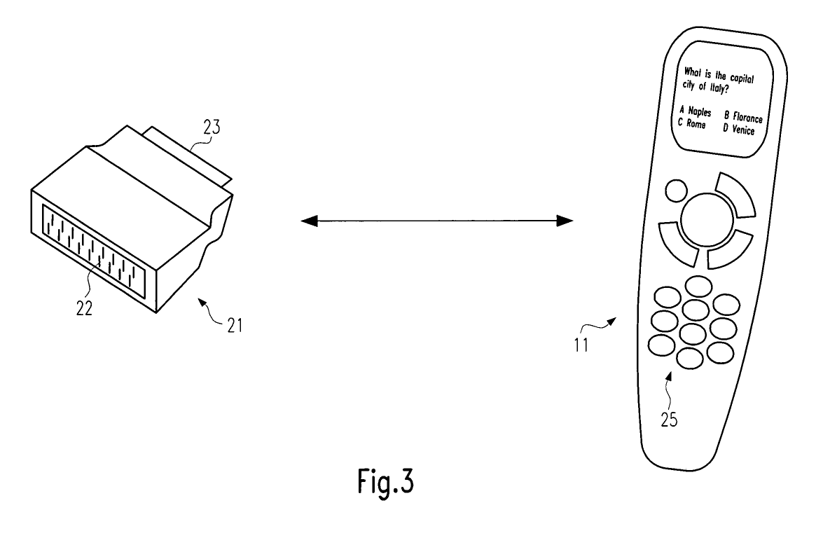

One particularly advantageous application of the present invention is in conjunction with interactive TV additional services, as will also be explained in more detail in conjunction with FIGS. 2 and 3. Particularly in the case of mass voting applications and games, the known solutions are highly disadvantageous. In the case of voting which has been initiated by broadcast radio, in particular from a television program, a telephone number is overlaid or is signaled orally, in which case a standard announcement, such as “This call will cost 49 cents from the landline network. Your call is being charged for”, must then be switched in the case of a telephone call from the subscriber. The invention allows an appropriate dialog to take place with the user in a peripheral device, for example a functionally processed remote control 11 for a TV set, and there is no need to set up a specific call number. Particularly in the case of games, only a fraction of the subscribers can take part, so that they can speak their names and addresses. The majority of subscribers are switched to “busy”, for capacity reasons. Information which has been stored in an appropriate form in advance, for example the transmission of a tag, from the remote control 11 or an input on it allows the identify of the caller to be transmitted in an extremely short time, without the caller himself having to make a telephone call. The agreement to billing can be checked by the remote control during the course of a dialog. The voting fee can be debited from a pre-pay account for the user, stored in the remote control. The call itself can then be toll-free, without any need for an announcement text. Overall, in conjunction with interactive television, the proportion of the profit which remains with the telecommunication providers can be increased in favor of the operator, in particular of the television transmitter, in this case also increasing the user convenience.

FIG. 2 now shows one preferred practical application of the present invention, in the form of a schematic overview. The illustration shows a TV receiver or television 17 which is preferably located in a domestic environment and can receive television signals in various ways. In this case, FIG. 1 shows, schematically, various transmission paths. To be more precise, the figure shows television reception by satellite, terrestrial television reception and cable-network television reception. These transmission paths can be used either individually or in conjunction in the context of the present invention. The television signals are transmitted on the various transmission paths from a television transmitter. Additional data which is applied to the television signal is preferably transmitted together with the television signal to the television set.

A large number of techniques are known from the prior art for this purpose. One particularly preferred option for application of additional data to the television signal is described in the German Patent Application with the official file reference 101 01 750.2 and entitled “Method for transmission of data by means of a television signal”, submitted to the German Patent and Trademark Office on 16 Jan. 2001, and the PCT publication WO 02/25924 A2, with the entire disclosure from both documents being included by virtue of this reference in the present application. According to this method, the additional data is not incorporated in the blanking interval, as in the case of conventional video text, but in the picture signal, that is to say in the part of the television signal which is displayed on the television set but cannot be seen by the television viewer. Since this method is particularly preferable in conjunction with the present invention, it will be described in more detail in the following text.

Various television standards are known in technology. In an entirely general form, a television signal comprises, in particular, an actual picture signal (B), the blanking signal (A) and the synchronization signal (S). The picture signal in this case has the information, obtained line-by-line, about the brightness distribution of an original picture that is to be transmitted. The time profile of the picture signal is interrupted during the horizontal and vertical beam flyback, that is to say it is “blanked out”. The blanking signal is formed by line-frequency horizontal blanking pulses and by vertical blanking pulses, which appear in time with the field change and are of a shorter duration than the horizontal blanking pulses. The synchronization signal is provided in order to allow the line raster which is written on the television tube to be synchronized at the reception end with the line raster at the transmission end. The synchronization signal also controls the deflection devices in the case of a recording and replay converter. In addition, a chrominance signal is also transmitted in order to allow compatible color picture transmission. In the case of broadcast television, a radio-frequency audio-carrier oscillation is generally frequency-modulated in order to transmit the accompanying audio.

The remote image transmission which is known according to the prior art occupies a broad and complex information channel, although this is not completely utilized. By way of example, no actual picture information, corresponding to the picture signal as defined above, is transmitted during a quarter of the transmission time. The synchronization information for the horizontal and vertical beam deflection is transmitted during the periodically recurring blanking intervals. Nevertheless, for example in accordance with the CIR 625-line standard, 17 full lines also nevertheless remain in each field, and these could be filled with additional information. However, according to the prior art, only approximately 12 lines are filled with test signals and data signals in each field. This transmission of additional test signals and/or data signals has no disturbing effect on the television viewer, because they are located within the vertical blanking.

One example of a data signal such as this is video text. Video text provides the television subscriber with the capability to see information from specific regions, in addition to the television program being offered, by means of written characters and graphics on the screen. The editorial processing is carried out by the broadcasting authorities and institutions supervised by them. The information provided includes, for example, up-to-date news, traffic information, weather reports, sports information and the like. Overlays relating to the current program, for example subtitles in the case of foreign-language programs, may, however, also likewise be provided. On the one hand, video text has the disadvantage that the amount of data which can possibly be transmitted is limited. It would thus be desirable if further capabilities were provided to transmit further information to the television receiver. A further disadvantage of video text is that complex hardware and software in the transmission studio must be linked to the picture signal to form the actual transmission signal for transmission of the known, additional test signals or data signals. The method for production of the transmission signal is therefore relatively complex, since complex synchronization, in some cases even manually, must be ensured in order to link the data signals with the actual “content”.

The method which was published in PCT publication WO 02/25924 A2 and provides a remedy to the above disadvantages of the teletext is based on the fundamental idea of a large number of lines in each field not being filled with data signals, for tolerance margin reasons. This is based on the idea that every television receiver has a so-called “cache” and thus makes only a portion of the active picture signal visible to the user. Since the size of the cache differs depending on the type of television set being used, these intervals are not used for data transmission, in order to avoid adversely affecting the viewing convenience of the television viewer. The fundamental idea of this already described method actually comprises, however, this prejudice being overcome and these previously unused intervals actually being used for data transmission. The situation in which the picture reproduction in the case of a television receiver having a correspondingly large cache is made worse is taken into account by designing the transmitted data to have a minimally invasive effect on the television picture.

One particular advantage in this case is that the data to be transmitted is not transmitted in the blanking interval, but together with the picture signal, that is to say the actual content. This simplifies the studio processing of the television signal, since there is no need to carry out any separate synchronization. The data can be transmitted independently of the transmitter in this way, as well. For example, an advertising spot in or together with which data is transmitted according to the invention can supply the same information to a television receiver irrespective of the transmitting transmitter.

The data is advantageously transmitted in the actual picture signal. This means that the data is also recorded with any form of recording of the picture signal, for example by means of a conventional video recorder and thus, in particular, is also available when the recording is replayed. Additional information can thus likewise be provided to a television viewer, from which, so to speak, one knows that a specific program signal is actually being received since the information is transmitted in the picture.

The method disclosed in the PCT publication WO 02/25924 A2 can be summarized as follows:

Method for transmission of data together with a television signal, which has a picture signal and a blanking signal, with the data being transmitted in an area which is located between the last line or column, which is filled with test or data signals, and a predetermined line or column in the picture signal. In this case, it is preferable for the data to be transmitted in the picture signal. In this case, it is preferable for the data to be transmitted in an edge area or in both vertical edge areas of the picture signal, in particular arranged spatially in the form of a column. In this case, it is preferable for the data to be included in the picture signal in the form of a barcode in the edge area of the picture signal. In this case, it is preferable for the line or lines, or column or columns, in which the data is transmitted to be predetermined in a fixed manner. In this case, it is preferable for the signal to be a ternary signal. In this case, it is also preferable for the television transmission signal to be formed by linking a signal which contains the data to be transmitted and has the picture signal, and a separate blanking signal. In this case, it is preferable for the data to be coded using an Internet standard. In this case, it is preferable for the Internet standard to be SGML or a derivative of it, in particular HTML or XML. In this case, it is preferable for the data to have text, graphics, pictures or programs and the like. In this case, it is preferable for the data to be transmitted in an area of the picture signal which essentially corresponds to the cache of a television receiver or is essentially contained in it. In this case, it is preferable for the data to be incorporated in an area of the picture signal which is suppressed by one or both vertical edge areas of the oval cache of the television receiver. In this case, it is also preferable for the data to be additionally transmitted in the blanking signal. However, in principle, it is also possible for the additional data to also be transmitted in a different manner in the picture signal, for example using so-called watermarking processes. However, it is likewise in principle possible to transmit the additional data by means of the video text.

Referring again to FIG. 1, the additional data which is preferably applied to the television picture in the form of a barcode in the picture signal is detected by a peripheral apparatus for a television set, which is shown as a plug-in module 21 in FIG. 1, and is inserted in the application in a SCART socket on the rear face of the television set, and is transmitted to a preferably portable, hand-held receiver apparatus. The SCART socket is in this case particularly preferable since this means that the picture signal which has currently been selected on a television set is externally accessible—without interfering with the television set—and the TV tuner of the television set operates, so to speak, for the method according to the invention. A remote control 11 for the television set is preferred as the receiver apparatus, which has a learning function, that is to say it can be programmed and used for all types of television sets. The receiver apparatus may also have other (main) functions and, for example, may be a mobile telephone, a PDA or an accessory for it. Furthermore, the receiver apparatus or remote control 11 has various additional functions which will be explained in more detail in the following text, for which all that will be done at this point is just to mention that the remote control can receive the additional data, which has been detected by the peripheral apparatus and applied to the picture signal, and can display it on a display area or display. Furthermore, as can be seen from the illustration in FIG. 2, a back-channel is also provided, via which data can be sent from the receiver apparatus to the apparatus 1 according to the invention, and over the telephone network, in particular the landline network, back to a computer center. The additional data which is transmitted from a service provider for the content management for interactive television (TV) to the computer center is also sent via the computer center to the television transmitter for application of the “video barcode” to the television signal. In this case, as shown in FIG. 2, the data is preferably transmitted using the Internet Protocol (IP). At this point, it should also be noted that the described exemplary embodiment is not restricted to the process of tapping off the television or picture signal via an interface, and in particular the SCART interface.

As a supplement to FIG. 1, the illustration in FIG. 3 shows one practical application of the apparatus 1 in the system as shown in FIG. 2. As described above, for example, a question relating to a game of chance and an associated answer are transmitted via the television signal to the SCART module 21. The SCART module 21 is in this case in the form of an intermediate plug, in the same way as the apparatus 1 as well, and has a plug section 22 and a socket section 23, in order not to block the SCART connection of the television set 17. The question and answer are now transmitted from the SCART module 21 to the remote control 11. The question is shown on the display 24 of the remote control. The user enters his answer via the keypad 25. In this case, the remote control 11 evaluates whether the answer is correct. The information relating to the game of chance is then transmitted to the apparatus 1 according to the invention, as shown in FIG. 1, and is sent back to the game of chance operator via the telephone network.

The invention has been explained in relatively great detail above with reference to preferred embodiments of it. However, it is obvious to a person skilled in the art that different variations and modifications can be carried out without departing from the fundamental idea of the invention.

What is claimed is:

1. An apparatus for transmission of data over a telephone line, comprising:
a first connection to connect a landline telephone to the apparatus;
a second connection to connect the apparatus to a landline telephone connection;
an RF receiver to receive data transmitted by radio to the apparatus, and/or an RF transmitter to transmit data by radio from the apparatus to a peripheral device; and
a modem device to transmit data from the apparatus over long distances via the landline connection and/or to receive data transmitted to the apparatus via the landline connection.

2. The apparatus as claimed in claim 1, wherein the apparatus further comprises a memory device to store the data which has been transmitted by radio or via the landline connection to the apparatus.

3. The apparatus as claimed in claim 2, wherein the apparatus further comprises a clock to initiate transmission of the data, which has been stored in the apparatus, over a long distance in response to a predetermined time.

4. The apparatus as claimed in claim 2, wherein long-distance transmission of the data which has been stored in the apparatus is initiated in response to the data which has been stored in the memory device reaching a predetermined memory occupancy.

5. The apparatus as claimed in claim 1, wherein the apparatus further comprises a central processing unit that processes data which has been transmitted to the apparatus and/or has been stored in the apparatus, for long-distance transmission.

6. The apparatus as claimed in claim 1, wherein the apparatus further comprises a telephone cable at one of whose ends the second connection is formed as a plug device, and at whose other end a physical unit is formed, which includes the first connection formed as a socket device.

7. The apparatus as claimed in claim 1, wherein the apparatus further comprises a power supply device, which takes the power which is required for operation of the apparatus from the landline connection.

8. The apparatus as claimed in claim 7, wherein the power supply device has at least two operating modes for supplying power, with a first operating mode being defined in that, when the landline connection is in a rest state, the power supply device takes power from the landline connection, with a resistance of the apparatus being greater than or equal to a first predetermined resistance value, and with a second operating mode being defined in that, in a busy state of the landline connection, the power supply device takes power from the landline connection, with the resistance of the apparatus being greater than or equal to a second predetermined resistance value.

9. The apparatus as claimed in claim 8, wherein the first predetermined resistance value is higher than the second predetermined resistance value.

10. The apparatus as claimed in claim 8, wherein the first predetermined resistance value for the first operating mode is approximately 1 MOhm.

11. The apparatus as claimed in claim 8, wherein the second predetermined resistance value for the second operating mode is approximately 700 Ohms.

12. The apparatus as claimed in claim 8, wherein the apparatus further comprises a storage device to store the power which has been taken from the landline telephone connection in the first and second operating modes.

13. The apparatus as claimed in claim 12, wherein the second operating mode is initiated automatically by the apparatus at a predetermined time and/or in response to the detection that a minimum threshold has been reached for the amount of power stored in the storage device.

14. The apparatus as claimed in claim 12, wherein the physical unit has one or more of the following components:
the second connection;
the RF receiver;
the RF transmitter;
the modem device;
a memory device to store the data which has been transmitted by radio or via the landline connection to the apparatus;
a clock to initiate transmission of the data, which has been stored in the apparatus, over a long distance in response to a predetermined time;
a central processing unit that processes data which has been transmitted to the apparatus and/or has been stored in the apparatus, for long-distance transmission;
the power supply device; and
the storage device.

15. The apparatus as claimed in claim 8, wherein the modem device initiates a dialed connection for taking power from the landline connection on the basis of the second operating mode in response to the detection of a lower threshold for the power which is stored in an energy store for the power supply device.

16. The apparatus as claimed in claim 1, wherein the RF receiver and the RF transmitter are in the form of an RF transceiver.

17. The apparatus as claimed in claim 1, wherein the RF receiver is continuously ready to receive.

18. The apparatus as claimed in claim 1, wherein the modem device initiates a dialed connection for long-distance transmission of the data in response to the reception of data which has been transmitted to the apparatus by radio.

19. The apparatus as claimed in claim 1, wherein the modem device is a packet modem.

20. The apparatus as claimed in claim 1, wherein data which has been transmitted to the apparatus by radio is decoded and is coded again for long-distance transmission.

21. The apparatus as claimed in claim 1, wherein the landline telephone which is connected to the apparatus is looped through the apparatus.

22. The apparatus as claimed in claim 1, wherein the landline telephone which is connected to the apparatus is conductively connected to the landline telephone connection when the apparatus is not activated for long-distance transmission of data, while the landline telephone is conductively isolated from the landline telephone connection when the apparatus is activated for long-distance transmission of data.

23. The apparatus as claimed in claim 1, wherein the apparatus further comprises a detection device capable of detecting that the landline telephone which is connected to the apparatus has gone off-hook, with any dialed connection which has been initiated by the modem device of the apparatus being interrupted when it is detected that the landline telephone has gone off-hook.

24. The apparatus as claimed in claim 1, wherein the apparatus further comprises an identifier device configured to identify a DTMF dialing signal of the landline telephone which is connected to the apparatus.

25. The apparatus as claimed in claim 1, wherein the apparatus further comprises a storage device configured to store a DTMF dialing signal of the landline telephone which is connected to the apparatus, in the apparatus.

26. The apparatus as claimed in claim 1, wherein the apparatus is capable of changing a DTMF dialing signal of the landline telephone which is connected to the apparatus.

27. The apparatus as claimed in claim 1, wherein the apparatus is capable of determining the best telephone tariff for the connected landline telephone and/or the long-distance data transmission of the apparatus, and is capable of setting up a connection in accordance with the tariff.

28. The apparatus as claimed in claim 1, wherein the RF receiver receives data which has been transmitted to the apparatus by radio from a large number of peripheral devices, with the data which has been transmitted to the apparatus from one peripheral device having an individual identification code for that peripheral device.

29. A system for provision of an interactive television service, comprising:
the apparatus of claim 1; and
a peripheral device for a television set, which includes: a receiving device to receive additional data, which is transmitted to a television set, together with the television signal; and a transmission device to transmit data to the apparatus.

30. The system as claimed in claim 29, wherein the additional data is contained in a program signal and is tapped off at the television set, is decoded, and is transmitted via a radio interface to the peripheral device.

31. The system as claimed in claim 29, wherein the peripheral device is a remote control for the television set.

32. A method for transmission of data over a telephone line, comprising:
providing an apparatus for transmission of data over a telephone line, comprising: a first connection to connect a landline telephone to the apparatus; a second connection to connect the apparatus to a landline telephone connection; an RF receiver to receive data transmitted by radio to the apparatus, and/or an RF transmitter to transmit data by radio from the apparatus to a peripheral device; and a modem device to transmit data from the apparatus over long distances via the landline connection and/or to receive data transmitted to the apparatus via the landline connection;
receiving data which has been transmitted to the apparatus by radio;
temporarily storing the data; and
long-distance transmitting the data via a landline connection, with a landline telephone being connected to the apparatus in such a manner that the landline telephone operating capability is not adversely affected by the apparatus.
